(19) United States
(12) Patent Application Publication
(10) Pub. No.: US 2013/0096227 A1
(43) Pub. Date: Apr. 18, 2013

(54) FORMULATIONS CONTAINING A PLASTICIZER AND FUNGICIDE AND ARTICLES MADE THEREFROM

(71) Applicants: Alexander Cornish, Basel (CH); Heinz Paul Herbst, Basel (CH)

(72) Inventors: Alexander Cornish, Basel (CH); Heinz Paul Herbst, Basel (CH)

(73) Assignee: LANXESS CORPORATION, Pittsburgh, PA (US)

(21) Appl. No.: 13/616,956

(22) Filed: Sep. 14, 2012

Related U.S. Application Data
(62) Division of application No. 12/519,882, filed on Nov. 19, 2009.

(30) Foreign Application Priority Data
Dec. 19, 2006 (GB) 0625312.4

(51) Int. Cl. C09D 5/14

(52) U.S. Cl. CPC C09D 5/14
USPC 523/122

(57) ABSTRACT

The present invention relates to formulations which comprise a plasticizer and articles made therefrom and/or coated therewith. More specifically the formulation comprises a plasticizer and a fungicidally effective amount of Fludioxonil and/or Difenoconazole. The formulations have particular application in the manufacture of plasticized articles and articles which have been coated with a fungicide containing plastisol.

The present invention relates to formulations which comprise a plasticizer and articles made therefrom and/or coated therewith. More specifically, the formulation comprises a plasticizer and a fungicidally effective amount of a particular fungicide or fungicides. The formulations have particular application in the manufacture of plasticized articles and articles which have been coated with a plastisol which contains a fungicide.

Plasticizers in flexible articles and articles coated with plastisol are particularly prone to fungal attack since the plasticizer acts as a carbon based nutrient source. Such fungal attack often leads to degradation of the plasticizer which in turn can result in loss of mechanical properties. Growth of fungi on the surface of plasticizer containing articles also leads to staining often accompanies by unpleasant smells. This can significantly affect the appearance of the article and can lead to an increased requirement for maintenance. Fungal growth in water contact applications for example pool liners can support biofilm formation also resulting in increased requirement for maintenance. On other items such as conveyor belts, in particular those belts which are responsible for carrying food/healthcare items, contamination can require much effort and expense to remedy.

The present invention is therefore directed towards, inter alia, the provision of a formulation having the following characteristics: (a) good efficacy against fungi which are capable of colonising and thus adversely affecting the technical integrity and/or cosmetic appearance of plasticizer containing articles; (b) exhibit good compatibility with the environment in which the plasticized article is used; (c) can be formulated and manufactured in a cost effective way; and (d) are stable during use and can be stored for a suitable period of time.

In addition to the above, in the light of environmental and governmental regulatory pressures, there is an increasing desire to reduce or eliminate certain compounds which are no longer acceptable for use in the treatment of such plasticized articles. The present invention therefore seeks to provide an improved formulation which does not contain any of the drawbacks of the formulations in the prior art.

Accordingly, the present invention provides a formulation comprising a plasticizer and a fungicide selected from the group consisting of: Fludioxonil and Difenoconazole and a mixture thereof.

We have now found that certain fungicides, that are mainly known for agricultural use, are surprisingly effective against fungi that are capable of growing on/infesting articles which comprise a plasticizer. In particular, surprisingly, such fungicides show good antifungal activity when they are incorporated into plasticizer containing formulations and this activity is retained following the processing of the formulation into the final plasticizer containing article such as a plasticized plastic material and/or an article which is coated with a plastisol.

Fludioxonil is listed as entry 368 The Pesticide Manual, Thirteenth Edition, published by The British Crop Protection Council, 2003. Fludioxonil is mainly known as a fungicide for use on crops and also as a seed treatment.

Difenoconazole is one known agricultural fungicide that is commercially available. Difenoconazole is described as entry 247 in The Pesticide Manual. Difenoconazole is mainly known as a systemic foliar fungicide for use over a wide range of crops, and also as a seed treatment.

In a particular embodiment the fungicide comprises Fludioxonil. In a further embodiment the fungicide comprises Difenoconazole. In a still further embodiment the fungicide comprises Fludioxonil and Difenoconazole.

The present invention still further provides a formulation as described above which additionally comprises Thiabendazole. Thiabendazole (2-(thiazol-4-yl)benzimidszole; 2-(1,3-thiazol-4-yl)benzimidazole) is also described in the Pesticide Manual under entry number (790). In a particular embodiment the formulation comprises as fungicidal active ingredient Fludioxonil and Thiabendazole. In a further embodiment the formulation comprises as fungicidal active ingredient Difenoconazole. In a still further embodiment the formulation comprises as fungicidal active ingredient Fludioxonil, Difenoconazole and Thiabendazole.

The present invention still further provides a formulation as described above wherein the fungicidal active ingredient additionally comprises a fungicide selected from the group consisting of Propioconazole (1-[2-(2,4-dichlorophenyl)-4-propyl-1,3-dioxolan-2-ylmethyl]-1H-1,2,4-triazole); Cyprodinil; Carbendazime; Tebuconazole; 10,10′-Oxybis-phenoxyarsen; Zink Pyrithione; 2-n isothiazolin-3-one; 2-n-Octyl-4-isothiazolin-3-on; n-butyl-1,2-benzisothiazolin-3-on; 4,5-Di-chlor-N-n-octyl-isothiazolin-3-on (DCOIT); 2-iodo-2-propynyl-n-butylcarbarnate; and mixtures thereof. All of these fungicides are well known to the person skilled in the art.

In a particular embodiment the formulation according to the invention comprises Fludioxonil, Thiabendazole and DCOIT. In a further embodiment the formulation according to the invention comprises Fludioxonil, Difenoconazole and DCOIT. In a still further embodiment the formulation according to the invention comprises Fludioxonil, Difenoconazole, Thiabendazole and DCOIT.

The formulations according to the invention may additionally comprise additional active ingredients in addition to those mentioned above. For example, the formulation may additionally comprise a further fungicide selected from the group consisting of: AC 382042 (N-(1-cyano-1,2-dimethylpropyl)-2-(2,4-dichlorophenoxy)propionamide), acibenzolar-S-methyl, alanycarb, aldimorph, anilazine, azaconazole, azafenidin, azoxystrobin and other strobilurin fungicides, benalaxyl, benomyl, benthiavalicarb, biloxazol, bitertanol, blasticidin S, boscalid (new name for nicobifen), bromuconazole, Bronopol, bupirimate, captafol, captan, carboxin, carpropamid, carvone, CGA 41396, CGA 41397, chinomethionate, chlorbenzthiazone, chlorothalonil, chlorozolinate, clozylacon, copper containing compounds such as copper oxychloride, copper oxyquinolate, copper sulphate, copper tallate, and Bordeaux mixture, cyamidazosulfamid, cyazofamid (IKF-916), cyflufenarnid, cymoxanil, cyproconazole, debacarb, di-2-pyridyl disulphide 1,1′-dioxide, dichlofluanid, diclocymet, diclomezine, dicloran, diethofencarb, difenzoquat, diflumetorim, diiodomethyl-p-tolylsufone (Amical, from Dow) O,O-di-iso-propyl-S-benzyl thiophosphate, dimefluazole, dimetconazole, dimethirimol, dimethomorph, dimoxystrobin, diniconazole, dinocap, dithianon, Dithiocarbamates, dodecyl dimethyl ammonium chloride, dodemorph, dodine, doguadine, edifenphos, epoxiconazole, ethaboxam, ethirimol, ethyl(Z)-N-benzyl-N([methyl(methyl-thioethylideneaminooxycarbonyl)amino]thio)-β-alaninate, etridiazole, famoxadone, fenamidone, fenarimol, fenbuconazole, fenfuram, fenhexamid, fenoxanil (AC 382042), fenpropidin, fenpropimorph, fentin acetate, fentin hydroxide, ferbam, ferimzone, fluazinam, flumetover, flumorph, fluoroimide, fluoxastrobin, fluquinconazole, flusilazole, flusulfamide, flutolanil, flutriafol, folpet, fosetyl-aluminium, fuberidazole, furalaxyl, furatnetpyr, guazatine, hexaconazole, hydroxyisoxazole, hymexazole, imazalil, imibenconazole, iminoctadine, iminoctadine triacetate, ipconazole, iprobenfos, iprodione, iprovalicarb, isopropanyl butyl carbamate, isoprothiolane, kasugamycin, kresoxim-methyl, LY186054, LY211795, LY 248908, mancozeb, maneb, MBT mefenoxam, mepanipyrim, mepronil, metalaxyl, metalaxyl M, metconazole, metiram, metiram-zinc, metominostrobin, metrafenone, MON65500 (N-allyl-4,5-dimethyl-2-trimethylsilylthiophene-3-carboxamide), myclobutanil, NTN0301, neoasozin, nickel dimethyldithiocarbarnate, nitrothale-isopropyl, nuarimol, 2-0-octyl-4-isothiazolin -3-one (Skane M 8 Rohm& Hass), ofurace, organomercury compounds, orysastrobin, oxadixyl, oxasulfuron, oxolinic acid, oxpoconazole, oxycarboxin, pefurazoate, penconazole, pencycuron, phenazin oxide, phosphorus acids, phthalide, picoxystrobin, polyoxin D, polyram, probenazole, prochloraz, procymidone, propamocarb, propamocarb hydrochloride, propineb, propionic acid, proquinazid, prothioconazole, pyraclostrobin, pyrazophos, Sodium Pyrithione, pyrifenox, pyrimethanil, pyroquilon, pyroxythr, pyrrolnitrin, quaternary ammonium compounds, quinomethionate, quinoxyfen, quintozene, silthiofam (MON 65500), S-imazalil, simeconazole, sipconazole, sodium pentachlorophenate, spiroxamine, streptomycin, sulphur, tecloftalam, tecnazene, tetraconazole, thifluzamide, 2-(thiocyanomethylthio)benzothiazole, thiophanate-methyl, thiram, tiadinil, timibenconazole, tolcloths-methyl, tolylfluanid, triadimefon, triadimenol, triazbutil, triazoxide, tricyclazole, tridemorph, trifloxystrobin, triflumizole, triforine, triticonazole, validamycin A, vapam, vinclozolin, XRD-563, zineb, ziram, zoxamide and compounds of the formulae:

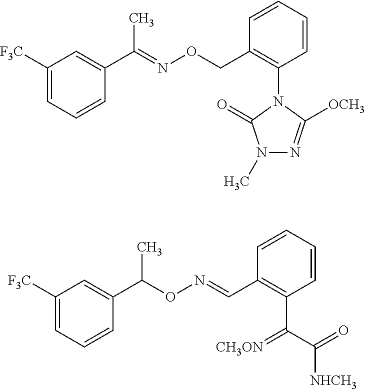

The formulation may also comprise an algaecide or herbicide, for example terbutryn, irgarol and prometryn. The formulation may additionally comprise an insecticide.

The antifungal active ingredients themselves may be formulated specifically for easy addition to the formulation of the invention. For example, the antifungal active ingredients may be in a powder or granule formulation.

The fungicide(s) used in the formulation of the invention may be added at a rate of between about 0.01 to about 10 parts inclusive, preferably about 0.025 to about 5 parts inclusive. When added as a mixture of fungicides, the ratio may be from about 0.5:20 to about 20:0.5 inclusive, preferably about 0.5:10 to about 10:0.5 inclusive.

Preferably, when the fungicidal mixtures are included in the formulations of the present invention they are included in amounts which provide for a synergistic effect. This synergistic effect may be demonstrated in vitro and/or in vivo. Such synergy not only brings about the enhancement of the spectrum of action with respect to the fungi to be controlled but achieves an effect which extends the range of action of the separate fungicides in two ways. Firstly, the rates of application of the fungicides can be lowered whilst the action remains equally good. Secondly, the active ingredient mixture still achieves a high degree of fungal control even where the individual components have become totally ineffective in such a low application rate range. This allows, on the one hand, a substantial broadening of the spectrum of fungi that can be controlled and, on the other hand, increased safety in use However, besides the actual synergistic action with respect to fungicidal activity, the formulation according to the invention can also have further surprising advantageous properties which can also be described, in a wider sense, as synergistic activity. Examples of such advantageous properties that may be mentioned are: activity towards resistant strains and improved characteristics of the articles which comprise the formulation of the invention.

With respect to formulations according to the present invention which comprise a mixture of different fungicides, synergism may be calculated based on the Colby equation, (COLBY, S.R. “Calculating synergistic and antagonistic response of herbicide combinations”. Weeds 15, pages 20-22; 1967).

The fungicides incorporated in the formulations of the present invention are effective against fungi which are capable of colonising articles which comprise a plasticizer.

Examples of problematic fungi are: Alternaria alternata, Alternaria tenuissima, Aureobasidium pullulans, Aspergillus flavus, Aspergillus niger, Aspergillus terreus, Aspergillus fumigatus, Aspergillus repens, Aspergillus versicolor, Candida albicans, Cladosporium cladosporioides, Cladosporium herbarum, Cladosporium sphaerospermum, Clostridium difficile, Coniophora puteana, Curvularia genticulata, Diplodia natalensis, Epidermophyton floccosum, Eurotium repens, Eurotium herbarioru, Fusarium oxysporum, Gliocladium virens, Gloeophyllum trabeum Humicola grisea, Lecythophora mutabilis, Lentinus cyathiformis, Lentinus lepidus, Memnionella echinata, Mucor indicus, Mucor racemosus, Oligoporus placenta, Paecilomyces variotii, Penicillium brevicompactum, Penicillium citrinum, Penicillium corylophilium, Penicillium crysogenum, Penicillium funiculosum, Penicillium ochrochloron, Penicillim polonicum, Penicillium purpurogenum, Penicillium pinophilum, Penicillium variabile, Petriella setifera, Phanerochaete chrysosporium, Phoma violacea, Poria placenta, Rhodotorula rubra, Schizophyllum commune, Sclerophoma phytiophila Scopulariopsis brevicaulis, Serpula lacrymans, Sporobolomyces roseus, Stachybotrys atra, Stachybotrys chartarum, Stemphyliurn dendriticum, Trichoderma harzianum, Trichoderma citrinoviride, Trichoderma atroviride, Trichoderma longibrachiatum, Trichophyton mentagrophytes, Trichurus spiralis, Trichophyton rubrum, Ulocladium atrum and Ulocladium chartarum and Wallemia sebi.

Of particular concern are: Alternaria alternata, Alternaria tenuissima, Aspergillus niger, Aspergillus versicolor, Aureobasidium pullulans, Chaetomium globosum, Cladosporium cladosporioides, Coniophora puteana, Gloeophyllum trabeum, Gliocladum virens, Memnionella echinata, Mucor indicus, Oligoporus placenta, Paecilomyces varoti, Penicillium citrinum, Penicillium funiculosum, Penicillium pinophilum, Sclerophoma phytiophila, Stachybotrys atra, Stachybotrys chartarum, and Ulocladium chartarum.

The present invention still further provides a formulation as described above which additionally comprises plastic. In a particular embodiment said plastic is a halogen containing polymer or a copolymer thereof. In a still further embodiment said plastic is selected from Polyvinyl chloride and polyvinylidene chloride.

Other examples of halogen-containing polymers which are applicable to the formulation of the present invention include: polychloroprene; chlorinated rubbers; chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers polyvinyl chloride (PVC), polyvinylidene chloride, polyvinyl fluoride, polyvinylidene fluoride as well as copolymers thereof such as vinyl chloride/vinylidene chloride, vinyl chloride/vinyl acetate, vinylidene chloride/vinyl acetate copolymers.

It is particularly preferred to use polymers of halogen-containing vinyl compounds including, polyvinyl chloride (PVC) and polyvinylidene chloride as well as copolymers thereof such as vinyl chloride/vinylidene chloride, vinyl chloride/vinyl acetate, vinylidene chloride/vinyl acetate copolymers in accordance with the present invention.

The present invention still further provides a plastisol comprising a formulation as described above. Plastisols are well known in the art and are generally defined as a plastic used as a solution or emulsion or paste for example for coating an article.

In use, the plasticizer may be added to the formulation at between about 10 to about 200 parts inclusive, preferably between about 20 to about 150 parts inclusive.

Typically, the formulations according to the invention will comprise the following ingredients: (A) a fungicide or fungicides as described above; (B) a plastic such as a halogen containing polymer or copolymer thereof; (C) a plasticizer; (D) a heat stabilizer and optionally other additives such as UV absorbers, light stabilizers, antioxidants, pigments, dyes, fillers, and reinforcing agents, flame retardants, antistatic agents, blowing agents, optical brighteners, processing aids and antimicrobials.

Fungicide(s) can also be added in a compounding step, via masterbatch or via direct dosing.

Additives can also be added in a compounding step, via masterbatch or via direct dosing.

Such ingredients would typically be added in the following quantities: (A) about 0.01 to about 10 parts; (B) about 100 parts; (C) about 10 to about 200 parts; and (D) about 03 to about 20 parts. It is possible to combine (A) with (C) in a premixed blend, i.e. to generate a separate formulation which comprises the fungicide(s) and the plasticizer. The fungicide(s) may also be combined with other ingredients in a premix blend.

The fungicide(s) may also be combined with the plasticizer or the halogen containing polymer or copolymer thereof or ethylene vinyl acetate or polymethacrylate copolymer to form a concentrate which allows easier dosing of the fungicide(s). Such concentrate contains the fungicide(s) in a concentration range between 1 to 80% inclusive, preferably between 2 to 40% inclusive.

The heat stabilizer (D) may be any of those known in the art. For example, mixed metal stabilizers (such as Barium/Zinc, Calcium/Zinc type, Organotin stabilizers (such as organo tin mercaptester, -carboxylate, -sulfide), Lead stabilizers (such as Tribasic lead sulfate, Dibasic lead stearate, Dibasic lead phthalate, Dibasic lead phosphate, lead stearate), organic based stabilizers and combinations thereof. Such stabilizers may be added to the formulation of the invention at between about 0.5 to about 20 parts inclusive, preferably about 0.5 to about 10 parts.

The present invention still further provides an article comprising a formulation as described above and/or which has been coated with a plastisol as described above. Examples of ways in which the article can be coated with a plastisol formulation according to the invention are by curtain coating, roller, brush, spray, atomisation, dipping, dusting, scattering or pouring application.

The present invention still further provides an article as described above wherein said article is selected from the group consisting of: roofing sheets, geomembrane, swimming pool liner, reservoir liner, wire jacketing, cable jacketing, flexible sealant, conveyor belts, hoses, wall covering, foamed articles, roller shutter, coated fabrics, protective clothing, shower curtains, coated fabrics, coated paper, coated metal surfaces, sport & leisure mats, rainwear and boots. Said article can also include bags, covering materials such as food and drinks coverings/containers, wrapping films and toys.

In a further aspect of the invention there is provided a plasticizer comprising a fungicide selected from the group consisting of: Fludioxonil and Difenoconazole and a mixture thereof. In a particular embodiment of the invention said plasticizer additionally comprises Thiabendazole. In a still further embodiment said plasticizer additionally comprises a fungicide as described above or a mixture thereof.

The present invention still further provides a plasticizer as described above wherein said plasticizer is selected from the group consisting of Di(2-ethylhexyl) phthalate, Disononyl phthalate, Diisodecyl phthalate, Dipropylheptyl phthalate, Trioctyl trimellitate, Tri(isononyl) trimellitate, epoxidized soy bean oil, Di(isononyl) cyclohexane-1,2-dicarboxcylate, 2,4,4-Trimethyl-1,3-pentaediol diisobutyrate.

The plasticizer as used in accordance with the invention may also comprise one selected from the group consisting of phthalates, trimellitates, aliphatic dibasic esters, polyesters, polymeric, epoxides, phosphates. In a preferred embodiment said plasticizer is selected from the group consisting of : Butyl benzyl phthalate, Butyl 2-ethylhexyl phthalate, Diisohexyl phthalate, Diisoheptyl phthalate, Di(2-ethylhexyl) phthalate, Diisooctyl phthalate, Di-n-octyl phthalate, Disononyl phthalate, Diisodecyl phthalate, Diiso undecyl phthalate, Diisotredecyl phthalate, Diiso (C₁₁, C₁₂, C₁₃) phthalate, Di(n-butyl) phthalate, Di(n-C₇, C₉) phthalate, Di(n-C₆, C₈, C₁₀) phthalate, Diiso(n-nonyl) phthalate, Di(n-C₇, C₉, C₁₁) phthalate, Di(n-C₉, C₁₁) phthalate, Di(n-undecyl) phthalate, Tri(n-C₈, C₁₀) trimellitate, Tri(2-ethylhexyl) trimellitate, Tri(isooctyl) trimellitate, Tri(isononyl) trimellitate, Di(n-C₇, C₉) adipate, Di(2-ethylhexyl) adipate, Di(isooctyl) adipate, Di(isononyl) adipate, Polyesters of adipinic acid or glutaric acid and propylene glycol or butylene glycol or 2,2-dimethyl-1,3-propanediol, Epoxidized oils such as epoxidized soy bean oil, epoxidized linseed oil, epoxidized tall oil, Octyl epoxy tallate, 2-ethylhexyl epoxy tallate, Isodecyl diphenyl phosphate, Tri(2-ethylhexyl) phosphate, Tricresyl phosphate, Di(2-ethylhexyl) terephthalate, Di(isononyl) cyclohexane-1,2-dicarboxcylate and combinations thereof. In a particularly preferred embodiment said plasticizer is selected from the group consisting of: Diisohexyl phthalate, Diisoheptyl phthalate, Di(2-ethylhexyl) phthalate, Diisooctyl phthalate, Di-n-octyl phthalate, Disononyl phthalate, Diisodecyl phthalate, Diiso undecyl phthalate, Diisotredecyl phthalate, Diiso (C₁₁, C₁₂, C₁₃) phthalate, Di(n-butyl) phthalate, Di(n-C₇, C₉) phthalate, Di(n-C₆, C₈, C₁₀) phthalate, Diiso(n-nonyl) phthalate, Di(n-C₇, C₉, C₁₁) phthalate, Di(n-C₉, C₁₁) phthalate, Di(n-undecyl) phthalate, Tri(n-C₈, C₁₀) trimellitate, Tri(2-ethylhexyl) trimellitate, Tri(isooctyl) trimellitate, Tri(isononyl) trimellitate, Di(n-C₇, C₉) adipate, Di(2-ethylhexyl) adipate, Di(isooctyl) adipate, Di(isononyl) adipate, Polyesters of adipinic acid or glutaric acid and propylene glycol or butylene glycol or 2,2-dimethyl-1,3-propanediol, Epoxidized oils such as epoxidized soy bean oil, Di(isononyl) cyclohexane-1,2-dicarboxcylate and combinations thereof.

The plasticizer may be added to the formulation of the invention at a rate of about 10 to about 200 parts inclusive, preferably about 20 to about 150 parts inclusive.

In a still further aspect of the invention there is provided a method of manufacturing a fungicide containing plasticized article said method comprising: (a) providing a formulation as described above and (b) generating an article from said formulation. Said article may be generated via methods well known to the skilled person such as moulding, extrusion, calendaring and rotomolding.

The present invention still further provides a method of manufacturing a fungicide containing plasticized article said method comprising: (a) providing an article or an article as described above and (b) coating said article with a plastisol as described above. In a particular embodiment of the invention said article is selected from the group consisting of: roofing sheets, geomembrane, swimming pool liner, reservoir liner, wire jacketing, cable jacketing, flexible sealant, conveyor belts, hoses, wall covering, foamed articles, roller shutter, coated fabrics, coated paper, coated metal surfaces, protective clothing, shower curtains, sport & leisure mats, rainwear and boots or an article as mentioned above.

The present invention still further provides the use of a fungicide selected from the group consisting of: Fludioxonil; Difenoconazole; and a mixture thereof in the manufacture of an article which comprises a plasticizer.

The present invention still further provides the use of a fungicide selected from the group consisting of: (a) Fludioxonil and Thiabendazole; (b) Difenoconazole and Thiabendazole; and (c) Fludioxonil and Thiabendazole and Difenoconazole in the manufacture of an article which comprises a plasticizer. In a further embodiment the invention provides the use of a fungicide according to those as mentioned in the preceding sentence which additionally comprises DCOIT.

In a particular embodiment there is provided the use as described above wherein said article comprises a plasticized halogen containing polymer or a plasticized copolymer thereof. In a particular embodiment said article comprises Polyvinyl chloride and polyvinylidine chloride. Said article may also comprise a plastic material as defined above.

The present invention still further provides the use of a fungicide selected from the group consisting of Fludioxonil; Difenoconazole; and a mixture thereof in the manufacture of a plasticizer containing plastisol.

The present invention still further provides the use of a fungicide selected from the group consisting of: (a) Fludioxonil and Thiabendazole; (b) Difenoconazole and Thiabendazole; and (c) Fludioxonil and Thiabendazole and Difenoconazole in the manufacture of a plasticizer containing plastisol. In a further embodiment the invention provides the use of a fungicide according to those as mentioned in the preceding sentence which additionally comprises DCOIT.

In a still further aspect of the invention there is provided an article comprising a plasticized halogen containing polymer or a plasticized copolymer thereof which comprises a fungicide selected from the group consisting of: Fludioxonil and Difenoconazole and a mixture thereof. In a particular embodiment said fungicide comprises Fludioxonil. In a further embodiment said fungicide comprises Difenoconazole. In a still further embodiment said article additionally comprises thiabendazole. In a still further embodiment said article additionally comprises DCOIT.

The present invention still further provides an article as described above wherein said halogen containing polymer comprises Polyvinyl chloride and polyvinylidine chloride.

The present invention still further provides an article which has been coated with a plastisol which comprises a formulation as described above.

The present invention still further provides an article as described above selected from the group consisting of roofing sheets, geomembrane, swimming pool liner, reservoir liner, wire jacketing, cable jacketing, flexible sealant, conveyor belts, hoses, wall covering, foamed articles, roller shutter, coated fabrics, coated paper, coated metal surfaces, protective clothing, shower curtains, sport & leisure mats, rainwear and boots or an article as mentioned above.

The invention will now be described with reference to the following non-limiting examples:

### EXAMPLE

### Typical Non Plasticized PVC Siding Formulation (without any Antifungal Ingredient)

| | | |
|---|---|---|
| PVC resin (K-value: 66-68) | 100 | parts |
| impact modifier | 4 | parts |
| heat stabilizer | 1 | part |
| Ca-stearate | 1 | part |
| Parafin wax | 1.2 | parts |
| processing aid | 1 | part |
| oxidized PE | 0.2 | parts |
| TiO2 | 1 | part |
| CaCO3 | 15 | parts |

### EXAMPLE

### Typical Plasticized PVC Formulation (without any Antifungal Ingredient)

| | |
|---|---|
| PVC resin (K-value: 70) | 100 parts |
| plasticizer (DOP/DIDP) | 67 parts |
| heat stabilizer | 13.6 parts |
| mineral oil | 0.5 parts |
| clay | 1.8 parts |

### EXAMPLE

### Typical Plastisol Formulation (without any Antifungal Ingredient)

| | | |
|---|---|---|
| PVC resin (K-value: >65) | 100 | parts |
| plasticizer | 40-120 | parts |
| heat stabilizer | 1-6 | parts |
| filler | 0-30 | parts |
| lubricants | 0-1 | parts |
| pigments | 0-5 | parts |

### EXAMPLE

### Dry Blend

For flexible PVC tests the following standard formulation is used:

| | |
|---|---|
| EVIPOL SH 7020 (S PVC K value 70) | 63.50 parts |
| VESTINOL DZ (DIDP) Plasticiser | 33.50 parts |
| REOPLAST 39 (epoxidized soy bean oil) | 1.50 parts |
| IRGASTAB BZ 561 (BaZn stabilizer) | 1.30 parts |
| TINUVIN 320 (UV absorber) | 0.20 parts |

The solid components are filled into the mixer (Papenmeier™) and stirred at 700 rpm and heated. The fungicides are premixed with plasticizer. As soon as the mixture temperature reaches 60° C. the liquid components are injected. The speed of the mixer is increased up to 1800 rpm and the temperature increased up to 100° C. When the 100 ° C. level is reached speed is reduced to 700 rpm and the mixture is cooled down to 50-60° C.

TABLE 1

| | Fludioxinil | Difenoconazole | Thiabendazole |
|---|---|---|---|
| | [weight % of dry | [weight % of dry | [weight % of dry |
| | blend] | blend] | blend] |
| Reference 1 | — | — | — |
| Example 1 | 0.1 | — | — |
| Example 2 | — | 0.1 | — |
| Example 3 | 0.1 | 0.1 | — |
| Example 4 | 0.05 | 0.05 | 0.05 |
| Example 5 | 0.05 | 0.05 | 0.007 |
| Example 6 | 0.05 | — | — |
| Example 7 | — | — | 0.05 |
| Example 8 | 0.025 | | 0.025 |
| Example 9 | — | 0.025 | 0.025 |

### EXAMPLE

### Roll Mill Sheets

100 g of the dry blend (Table 1) is given on a two roll mill (Schwabenthan D-1™) and homogenized at 150-160° C. for 8 min. 400 micron thick sheets are prepared.

### EXAMPLE

### Antifungal Tests

TABLE 2
ASTM G21-96 against Chaetomonium globosum ATCC 6205

| | Zone of inhibition |
|---|---|
| | [mm] |
| Reference 1 | 0 |
| Example 1 | 20 |
| Example 2 | 5 |
| Example 3 | 21 |
| Example 4 | 18 |
| Example 5 | 18 |

The test has been performed according to the standard ASTM G21-96 Method. Test Fungi is Chaetomonium globosum ATCC 6205.

The petri dishes are evaluated for zone of inhibition around the test specimen after 28 days exposure time. The results of this test are summarized in Table 2.

The reference sample shows no zone of inhibition whereas the inventive examples show no growth of Chaetomonium globosum around the samples expressed by a zone of inhibition.

TABLE 3
ISO 846 Method B against a mixture of fungi
Aspergillus niger ATCC 6275; Penicillium funiculosum IMI 104624;
Paecilomyces varioti ATCC 1114; Gliocladum virens ATCC 9645;
Chaetomium globosum ATCC 6205

| | Growth on the sample |
|---|---|
| | [%] |
| Reference 1 | 100 |
| Example 6 | 100 |
| Example 7 | 10 |
| Example 8 | 0 |
| Example 9 | 5 |

The test is performed according to ISO 846 Method B against a mixture of fungi.

The specimens are evaluated via microscope for fungal growth on the specimen after 28 days exposure time. The results are summarized in table 3.

The reference 1 shows 100% growth on the surface whereas examples 7-9 show a significantly reduced growth. Additionally Examples 8 and 9 show a synergistic effect, since the performance of these examples exceed the performance of example 6 and 7 at the same total loading.

The plasticized formulations according to the invention which contain an antifungal active ingredient demonstrate good overall antifungal efficacy.

### EXAMPLE

### PVC Membrane Dry Blend (1)

| | | |
|---|---|---|
| S PVC | 100 | parts |
| Plasticiser (DINP) | 52 | parts |
| Epoxidized soy bean oil | 5 | parts |
| CaZn stabilizer | 1.50 | parts |
| Filler (CaCO₃) | 5 | parts |
| Modifier | 2.5 | parts |

The PVC membrane dry blend is mixed together with the components in Table 4 via a high speed mixer (Henschel)

TABLE 4

| | TINUVIN XT 833 | | |
|---|---|---|---|
| | (light stabilizer) | Fludioxinil | Thiabendazole |
| | [weight % of dry | [weight % of dry | [weight % of dry |
| | blend] | blend] | blend] |
| Reference 2 | 0.3 | — | — |
| Example 10 | 0.3 | — | 0.1 |
| Example 11 | 0.3 | 0.02 | 0.08 |
| Example 12 | 0.3 | 0.025 | 0.075 |
| Example 13 | 0.3 | 0.033 | 0.067 |
| Example 14 | 0.3 | 0.05 | 0.05 |

### EXAMPLE

### Roll Mill Sheets

100 g of the dry blend (membrane dry blend+Table 4) is given on a two roll mill (Schwabenthan D-1™) and homogenized at 150-160° C. for 8 min. 400 micron thick sheets are prepared.

These sheets ate stored in distilled water at 60° C. for 30 days.

TABLE 5
ISO 846 Method B against a mixture of fungi
Aspergillus niger ATCC 6275; Penicillium funiculosum IMI 104624;
Paecilomyces varioti ATCC 1114; Gliocladum virens ATCC 9645;
Chaetomium globosum ATCC 6205

| | Growth on the sample |
|---|---|
| | [%] |
| Reference 2 | 100 |
| Example 10 | 100 |
| Example 11 | 40 |
| Example 12 | 0 |
| Example 13 | 0 |
| Example 14 | 0 |

The test is performed according to ISO 846 Method B against a mixture of fungi.

The specimens are evaluated via microscope for fungal growth on the specimen after 28 days exposure time. The results are summarized in table 5.

The reference 2 and the formulation with Thiabendazole alone (example 10) shows 100% growth on the surface whereas examples 11-14 show a significantly reduced growth.

The plasticized formulations according to the invention which contain an antifungal active ingredient demonstrate good overall antifungal efficacy.

### EXAMPLE

### Membrane Dry Blend (2)

| | | |
|---|---|---|
| S PVC | 100 | parts |
| Plasticiser (DINP) | 52 | parts |
| Epoxidized soy bean oil | 5 | parts |
| CaZn stabilizer | 1.50 | parts |
| Filler (CaCO₃) | 5 | parts |
| Modifier | 2.5 | parts |

The PVC membrane dry blend is mixed together with the components in Table 6 via a high speed mixer (Henschel)

TABLE 6

| | Fludioxinil | Thiabendazole | DCOIT |
|---|---|---|---|
| | [weight % of dry | [weight % of dry | [weight % of dry |
| | blend] | blend] | blend] |
| Reference 3 | — | — | — |
| Example 15 | | | 0.05 |
| Example 16 | 0.02 | 0.03 | — |
| Example 17 | 0.01 | 0.03 | 0.01 |

TABLE 7
ISO 846 Method B against a mixture of fungi
Aspergillus niger ATCC 6275; Penicillium funiculosum IMI 104624;
Paecilomyces varioti ATCC 1114; Gliocladum virens ATCC 9645;
Chaetomium globosum ATCC 6205

| | Growth on the sample |
|---|---|
| | [%] |
| Reference 3 | 100 |
| Example 15 | 50 |
| Example 16 | 0 |
| Example 17 | 0 |

The test is performed according to ISO 846 Method B against a mixture of fungi.

The specimens are evaluated via microscope for fungal growth on the specimen after 28 days exposure time. The results are summarized in table 7.

The reference 2 and the formulation with DCOIT alone (example 10) shows growth (reference 100% growth, DCOIT alone 50% growth) on the surface whereas examples 16-17 show a significantly reduced growth.

The plasticized formulations according to the invention which contain an antifungal active ingredient demonstrate good overall antifungal efficacy.

1-6. (canceled)

7. A method of protecting a plasticized article from fungal attack, comprising:
(a) preparing a first mixture comprising Fludioxonil, Thiabendazole, and 4,5-Di-chlor-N-n-octyl-isothiazolin-3-on;
(b) preparing a second mixture comprising a plastic and a plasticizer; and
(c) mixing the first and second mixture, thereby forming a third mixture; and
(e) generating the plasticized article from said third mixture,
wherein the ratio of the Fludioxonil to the Thiabendazole to the 4,5-Di-chlor-N-n-octyl-isothiazolin-3-on is 1:3:1.

8. The method according to claim 7, further comprising:
(f) coating the plasticized article with a plastisol.

9. The method according to claim 7 wherein said plastic is a halogen containing polymer or a copolymer thereof.

10. The method according to claim 7, wherein said plastic is selected from the group consisting of polychloroprene; chlorinated rubber; chlorinated and brominated copolymer of isobutylene-isoprene (halobutyl rubber), chlorinated polyethylene, sulfochlorinated polyethylene, copolymers of ethylene and chlorinated ethylene, epichlorohydrin homo- and copolymers polyvinyl chloride (PVC), polyvinylidyne chloride, polyvinyl fluoride, polyvinylidene fluoride, vinyl chloride/vinylidene chloride, vinyl chloride/vinyl acetate, and vinylidene chloride/vinyl acetate copolymers.

11. The method according to claim 7, wherein the Fludioxonil is present an amount of 0.02 weight %, the Thiabendazole is present an amount of 0.02 weight %, and the 4,5-Di-chlor-N-n-octyl-isothiazolin-3-on is present an amount of 0.02 weight %, said weight % being based on the amount of the second mixture.
